(19) United States
(12) Patent Application Publication
(10) Pub. No.: US 2026/0264158 A1
(43) Pub. Date: Sep. 10, 2026

(54) WELDING METHOD FOR BIMETAL COMPOSITE PIPES FOR ACIDIC ENVIRONMENT

(71) Applicant: SOUTHWEST PETROLEUM UNIVERSITY, CHENGDU (CN)

(72) Inventors: DEZHI ZENG, CHENGDU (CN); JIANCHENG LUO, CHENGDU (CN); JIE LI, CHENGDU (CN); CHENGXIU YU, CHENGDU (CN); RUIKANG KE, CHENGDU (CN); GUANGGUANG XIANG, CHENGDU (CN); LIN YU, CHENGDU (CN); JINGYUAN XU, CHENGDU (CN); ZHENGPENG DU, CHENGDU (CN)

(21) Appl. No.: 19/433,309

(22) Filed: Dec. 26, 2025

(30) Foreign Application Priority Data
Mar. 7, 2025 (CN) 202510267744.8

(51) Int. Cl. B23K 9/028; B23K 9/167; B23K 9/173; B23K 9/235; B23K 31/12; B23K 101/06

(52) U.S. Cl. CPC B23K 9/0282; B23K 9/167; B23K 9/173; B23K 9/235; B23K 31/12; B23K 2101/06

(57) ABSTRACT

A welding method for bimetal composite pipes for an acidic environment, includes the following steps: (1) machining of a stepped notch; (2) preparation of cladding powder; (3) cleaning and preheating of the composite pipe; (4) laser cladding surfacing; (5) groove designing and machining; (6) groove cleaning and preheating; (7) adding of an isolation layer to the groove; (8) groove cleaning and fit-up; (9) welding and filing of a base layer; and (10) welding of a base layer cover. The welding of composite pipes of the present disclosure is divided into two parts: pre-welding treatment in the factory and post-welding treatment on the site, where the pre-welding treatment in the factory uses advanced equipment and technique such as laser cladding to perform groove pretreatment.

### CROSS REFERENCE TO RELATED APPLICATIONS

The present disclosure claims the priority to the Chinese patent application with the filing No. 202510267744.8, entitled “WELDING METHOD FOR BIMETAL COMPOSITE PIPES FOR ACIDIC ENVIRONMENT” and filed on Mar. 7, 2025 with the Chinese Patent Office, the contents of which are incorporated herein by reference in their entirety.

### TECHNICAL FIELD

The present disclosure relates to the technical field of pipe welding, and more particularly to a welding method for bimetal composite pipes for an acidic environment.

### BACKGROUND ART

As oil and gas exploitation gradually shifts toward acidic gas fields with high sulfur content and other acidic components, conventional anti-corrosion techniques and pipe materials are unable to ensure the safe transportation of oil and gas. Bimetal composite pipes are widely used in the petrochemical industry, because they combine the mechanical properties of the base pipe (usually of carbon steel) with the corrosion resistance properties of the liner pipe (usually of corrosion-resistant alloy steel). However, due to the special manufacturing process of the bimetal composite pipes, welding process is an important factor affecting the development of bimetal composite pipes.

Currently, the welding techniques for bimetal composite pipes include pipe end seal welding and surfacing. Seal welding offers the advantage of low cost, but seal welding is prone to generating cracks, affecting weld quality; while surfacing, utilizing metallurgical bonding principles, can effectively reduce occurrence of weld seam cracks. However, during the welding process, the surfacing process is prone to inducing element migration at the bonding part between the base pipe and the liner pipe, thereby affecting the corrosion resistance of the weld seam, and hindering the long-term operation of the composite pipe. Meanwhile, during the surfacing process, it is prone to causing large deformation at the pipe ends, which is unfavorable for subsequent welding fit-up. In addition, the equipment required for surfacing is complex and is difficult to handle at the construction site.

Laser cladding is a process that uses the instantaneous energy generated by a high-energy laser beam to rapidly melt the material surface and the powder thereon, followed by solidifying to form a cladding layer with low dilution rate, belonging to a type of additive manufacturing technique. Compared with the surfacing process, laser cladding has a small heat input, does not cause thermal deformation of the cladding layer, and results in a cladding layer with a dense structure and a low dilution rate. However, the current use of laser cladding for welding bimetal composite pipes is still in the development stage, and it faces problems of high cost, expensive equipment, and difficulty in on-site construction to directly adopt laser cladding for welding.

Therefore, the problem urgently to be solved by those skilled in the art is how to leverage the advantages of laser cladding and simultaneously avoid the above-mentioned drawbacks.

### SUMMARY

In view of this, the purpose of the present disclosure is to provide a welding method for bimetal composite pipes for an acidic environment, so as to solve the shortcomings in the prior art, such as the decrease in corrosion resistance and thermal deformation of the pipe end caused by element migration during the welding process of composite pipes, as well as the problems of difficulties in implementing the laser cladding technique on site.

To achieve the above purpose, the present disclosure adopts the following technical solutions.

A welding method for bimetal composite pipes for an acidic environment specifically includes the following steps:

### (1) Machining of a Stepped Notch

first, preparing a finished bimetal composite pipe formed by hydroforming, cleaning the surface and end face, and then cutting off a certain range of one side of the pipe end near the liner pipe to form the stepped notch;

### (2) Preparation of Cladding Powder

mixing carbon powder, chromium powder, niobium powder, silicon powder, molybdenum powder, manganese powder, iron powder and nickel powder evenly to obtain surfacing layer powder and isolation layer powder respectively;

### (3) Cleaning and Preheating of the Composite Pipe

performing cleaning and preheating treatment on the bimetal composite pipe with the stepped notch machined in step (1);

### (4) Laser Cladding Surfacing

loading the surfacing layer powder in step (2) into a powder feeder of the laser cladding equipment, keeping the composite pipe rotating, cladding the surfacing layer powder in the stepped notch in step (1) by using the synchronous laser cladding process in the cladding direction from the inside to the outside, pausing the laser cladding equipment after the surfacing layer is formed, where the roundness deviation range of the inner wall surface of the surfacing layer is 0.5%~1%; and polishing the end face of the surfacing layer so that the end face of the surfacing layer is flush with the end face of the composite pipe;

### (5) Groove Designing and Machining

machining a V-shaped groove at the end face of the composite pipe after the surfacing in step (4);

### (6) Groove Cleaning and Preheating

performing cleaning and preheating treatment on the V-shaped groove of the end face of the composite pipe in step (5);

### (7) Adding of an Isolation Layer to the Groove

loading the isolation layer powder in step (2) into the powder feeder of the laser cladding equipment, keeping the composite pipe rotating, cladding the isolation layer powder on the inclined surface of the V-shaped groove in step (5) by using the synchronous laser cladding process in the cladding direction from the inside to the outside, and stopping the laser cladding equipment after the isolation layer is formed;

### (8) Groove Cleaning and Fit-Up

performing quality inspecting and cleaning on the grooves of two processed to-be-welded composite pipes to ensure that the grooves and the surrounding areas thereof are intact, bright and clean, and then performing groove fit-up;

### (9) Welding and Filling of a Base Layer

performing base layer welding on the bottom of the groove by using a tungsten inert gas welding under inert gas protection to form a base weld layer, then performing fill welding on the base weld layer by using the tungsten inert gas welding to form a first fill layer, a second fill layer and a third fill layer; and

### (10) Welding of a Base Layer Cover

performing cover welding (capping pass) on the base layer by using shielded metal arc welding to form a cover layer.

In the present disclosure, steps (1) to (7) are pre-welding treatments in the factory, and steps (8) to (10) are post-welding treatments on the site.

Further, in step (1) above, the stepped notch has a height a of 2.5~4 mm and a depth b of 8~12 mm, and the wall thickness L₂ of the liner pipe<the height a of the notch<the wall thickness (L₁+L₂) of 25% bimetal composite pipe.

Further, in step (2) above, the surfacing layer powder and the isolation layer powder, by mass percentage, each include 0.01%~0.03% of carbon powder, 21%~22% of chromium powder, 3%~3.5% of niobium powder, 0.01%~0.1% of silicon powder, 8%~10% of molybdenum powder, 0.1%~0.3% of manganese powder and 1%~5% of iron powder, with the balance being nickel powder.

Further, in step (2) above, the surfacing layer powder and the isolation layer powder each have a particle size of 5~50 μm, and a sphericity of 0.7~0.9.

Further, in step (3) and step (6) above, the temperature for the preheating treatment is 80~250° C.

Further, in step (4) and step (7) above, the parameters of the synchronous laser cladding process are: laser power of 2000~4500 W, a powder feeding speed of 5~15 g/min, a spot diameter of 0.1~0.5 mm, a scanning speed of 90~450 mm/min, and protective gas of argon.

Further, in step (5) above, the V-shaped groove has a blunt edge length c of 3~6 mm, a blunt edge thickness d of 2~2.5 mm, and a single-sided groove angle β of 30°±3°.

Further, in step (7) above, the height of the isolation layer is uniform and consistent, the single-sided groove angle β is maintained at 30°±3°, and the thickness e is 2~5 mm.

Further, in step (8) above, the gap of the groove fit-up is 2~3 mm.

Further, in step (9) above, the welding material for the base layer welding is a welding wire with a composition similar to that of the liner pipe, where the mass ratio of Cr to Ni is not less than 1:3, the welding current is 90~110 A, and the welding speed is 3~4 cm/min.

Further, in step (9) above, the welding material for the fill welding is a welding wire with a composition similar to that of the liner pipe, where the mass ratio of Cr to Ni is not less than 1:3, the welding current is 90~110 A, and the welding speed is 4~6 cm/min.

Further, in step (10) above, the welding material for the cover welding is a welding wire with a composition similar to that of the liner pipe, where the mass ratio of Cr to Ni is not less than 1:3, the welding current is 50~70 A, and the welding speed is 7~9 cm/min.

As can be seen from the above technical solutions, compared with the prior art, the beneficial effects of the present disclosure are as follows.
1. Laser cladding technique is used to achieve metallurgical bonding between the base pipe and the liner pipe at the end of the composite pipe, which not only improves the bonding strength but also reduces the dilution rate of the bonding part to ensure the corrosion resistance of the weld seam; and meanwhile, the surfacing layer formed by laser cladding has high forming precision, thereby reducing the cost of subsequent polishing and machining.
2. An isolation layer is cladded onto the inclined surface of the groove to prevent carbon element in the base pipe from migrating to the weld seam during groove welding; and meanwhile, the isolation layer can ensure excellent corrosion resistance of the end face to avoid the problem of groove corrosion before on-site butt welding of composite pipes.
3. The welding of composite pipes is divided into two parts: pre-welding treatment in the factory and post-welding treatment on the site, where the pre-welding treatment in the factory uses advanced equipment and technique such as laser cladding to perform groove pretreatment, facilitating the subsequent on-site application of mature techniques such as tungsten inert gas welding and shielded metal arc welding for direct post-welding treatment of composite pipes, thereby saving on-site welding process costs and improving welding quality and efficiency.

### BRIEF DESCRIPTION OF DRAWINGS

FIG. 1 is a schematic flowchart of the welding method of the present disclosure;

FIG. 2 is a schematic flowchart of the groove machining design in the welding method of the present disclosure;

FIG. 3 is a schematic view showing the machining direction of the laser cladding of the surfacing layer in the welding method of the present disclosure;

FIG. 4 is a schematic view showing the machining direction of the laser cladding of the isolation layer in the welding method of the present disclosure;

FIG. 5 is a schematic structural view of the groove in the welding method of the present disclosure; and

FIG. 6 is a schematic structural view of the weld layer after groove welding in the welding method of the present disclosure;

in the above, 1—base pipe, 2—liner pipe, 3—stepped notch, →-surfacing layer, 5—inclined surface of the V-shaped groove, 6—isolation layer, 7—base weld layer, 8—first fill layer, 9—second fill layer, 10—third fill layer, 11—cover layer.

### DETAILED DESCRIPTION OF EMBODIMENTS

The technical solutions in the embodiments of the present disclosure will be clearly and completely described below. Obviously, the described embodiments are only some embodiments of the present disclosure, and not all embodiments. Based on the embodiments of the present disclosure, all other embodiments obtained by those ordinarily skilled in the art without creative effort fall within the scope of protection of the present disclosure.

### Example 1

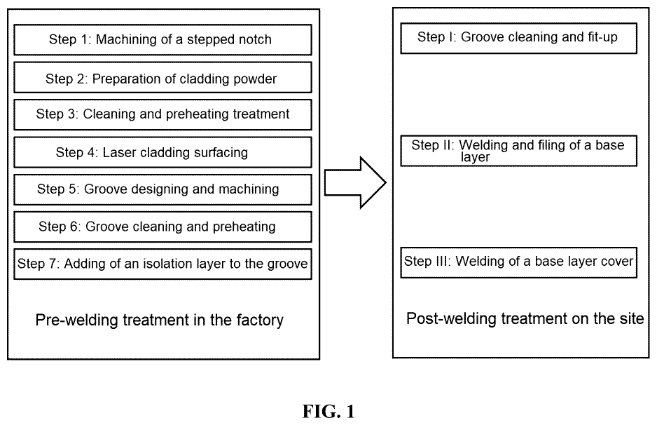

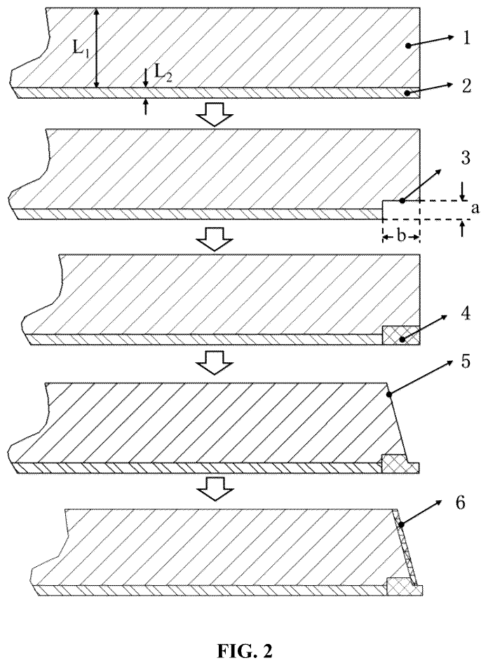

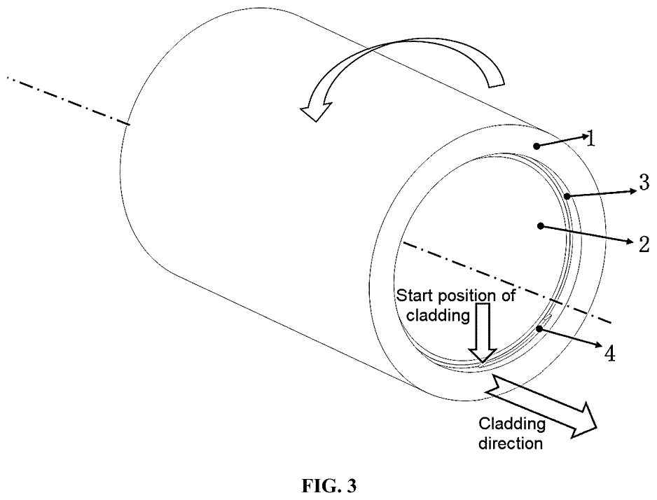

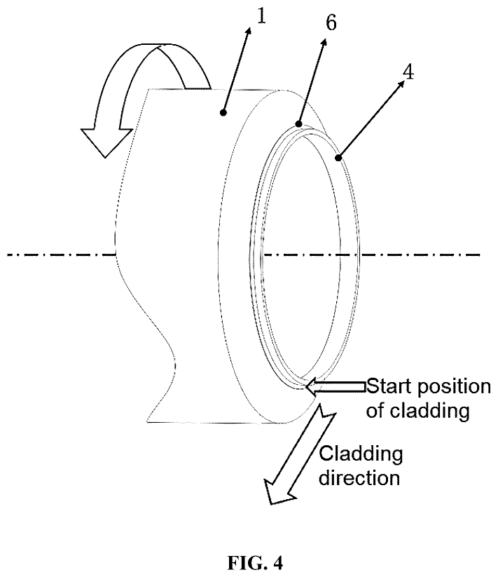

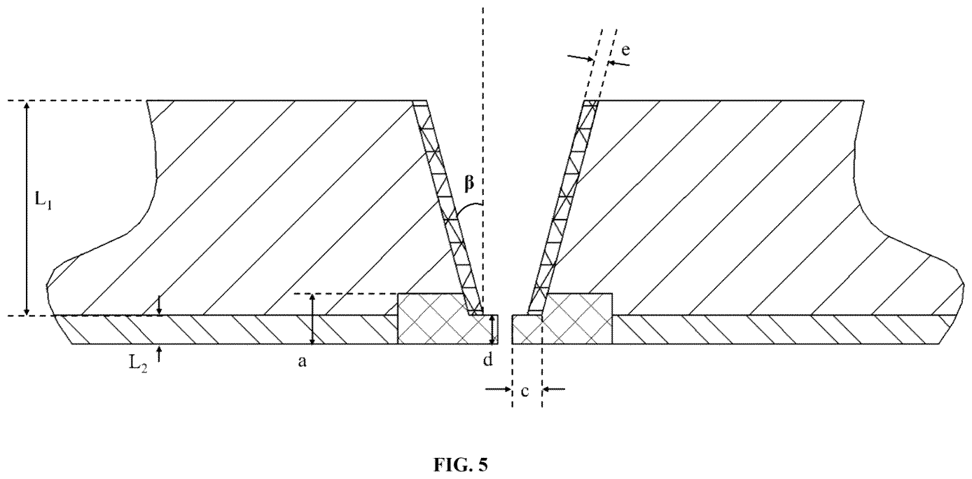

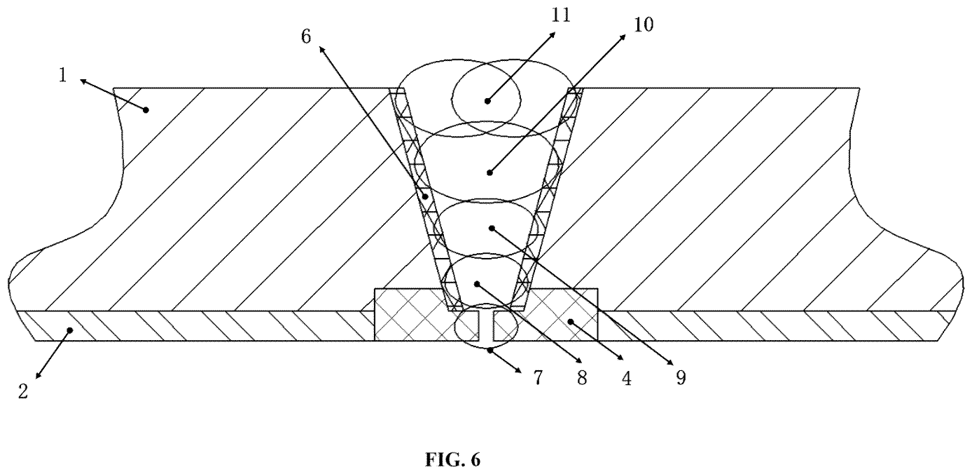

The welding method for bimetal composite pipes for an acidic environment, as shown in FIGS. 1-6, specifically included the following steps:

### (1) Machining of a Stepped Notch

first, preparing a finished bimetal composite pipe Φ219 formed by hydroforming, where the base pipe 1 was made of a material of L360QS, and had a wall thickness L₁ of 13 mm, and the liner pipe 2 was made of a material of 825, and had a wall thickness L₂ of 2 mm; and cleaning the surface and end face, and then cutting off a certain range of one side of the pipe end near the liner pipe 2 to form a stepped notch 3 with the height a of 3.5 mm and the depth b of 9 mm, where the wall thickness L₂ (2 mm) of the liner pipe 2<the height a (3.5 mm) of the notch<the wall thickness (15 mm) of 25% bimetal composite pipe;

### (2) Preparation of Cladding Powder

weighing out 0.15 g of carbon powder, 105.7 g of chromium powder, 16.5 g of niobium powder, 0.49 g of silicon powder, 42.2 g of molybdenum powder, 1.5 g of manganese powder, 19.4 g of iron powder, and 299.06 g of nickel powder, and mixing evenly to obtain surfacing layer powder and isolation layer powder respectively, with the particle size of 20 μm and the sphericity of 0.8;

### (3) Cleaning and Preheating of the Composite Pipe

performing cleaning and 100° C. preheating treatment on the bimetal composite pipe with the stepped notch 3 machined in step (1);

### (4) Laser Cladding Surfacing

loading the surfacing layer powder in step (2) into a powder feeder of the laser cladding equipment, keeping the composite pipe rotating, cladding the surfacing layer powder in the stepped notch 3 in step (1) by using the synchronous laser cladding process in the cladding direction from the inside to the outside, pausing the laser cladding equipment after the surfacing layer 4 was formed, where the roundness deviation range of the inner wall surface of the surfacing layer 4 was 0.7%; and polishing the end face of the surfacing layer 4 so that the end face of the surfacing layer 4 was flush with the end face of the composite pipe,
where the parameters of the synchronous laser cladding process were: laser power of 2100 W, a powder feeding speed of 10 g/min, a spot diameter of 0.2 mm, a scanning speed of 100 mm/min, and protective gas of argon;

### (5) Groove Designing and Machining

machining a V-shaped groove at the end face of the composite pipe after the surfacing in step (4), where the blunt edge length c was 5 mm, the blunt edge thickness d was 2 mm, and the single-sided groove angle β was 30°;

### (6) Groove Cleaning and Preheating

performing cleaning and 100° C. preheating treatment on the V-shaped groove of the end face of the composite pipe in step (5);

### (7) Adding of an Isolation Layer to the Groove

loading the isolation layer powder in step (2) into the powder feeder of the laser cladding equipment, keeping the composite pipe rotating, cladding the isolation layer powder on the inclined surface 5 of the V-shaped groove in step (5) by using the synchronous laser cladding process in the cladding direction from the inside to the outside, and stopping the laser cladding equipment after the isolation layer 6 was formed, where the height of the isolation layer was uniform and consistent, the single-sided groove angle β was maintained at 30°, and the thickness e was 3 mm,
where the parameters of the synchronous laser cladding process were: laser power of 2100 W, a powder feeding speed of 10 g/min, a spot diameter of 0.2 mm, a scanning speed of 100 mm/min, and protective gas of argon;

### (8) Groove Cleaning and Fit-Up

performing quality inspecting and cleaning on the grooves of the two processed to-be-welded composite pipes to ensure that the grooves and the surrounding areas thereof were intact, bright and clean, and then performing groove fit-up, where the gap was 3 mm;

### (9) Welding and Filing of a Base Layer

performing base layer welding on the bottom of the groove by using tungsten inert gas welding under inert gas protection to form a base weld layer 7, and then performing fill welding on the base weld layer 7 by using the tungsten inert gas welding to form a first fill layer 8, a second fill layer 9 and a third fill layer 10,
where the welding material for the base layer welding was a welding wire with a composition similar to that of the liner pipe 2, where the mass ratio of Cr to Ni was 1:3, the welding current was 100 A, and the welding speed was 3.5 cm/min, and
the welding material for the fill welding was a welding wire with a composition similar to that of the liner pipe 2, where the mass ratio of Cr to Ni was 1:3, the welding current was 100 A, and the welding speed was 5 cm/min; and

### (10) Welding of a Base Layer Cover

performing cover welding on the base layer by using shielded metal arc welding to form a cover layer 11,
where the welding material for the cover welding was a welding wire with a composition similar to that of the liner pipe, where the mass ratio of Cr to Ni was 1:3, the welding current was 60 A, and the welding speed was 7 cm/min.

### Example 2

The welding method for bimetal composite pipes for an acidic environment, as shown in FIGS. 1-6, specifically included the following steps:

### (1) Machining of a Stepped Notch

first, preparing a finished bimetal composite pipe Φ273 formed by hydroforming, where the base pipe 1 was made of a material of X60 and had a wall thickness L₁ of 15 mm, and the liner pipe 2 was made of a material of 625 and had a wall thickness L₂ of 2 mm; and cleaning the surface and end face, and then cutting off a certain range of one side of the pipe end near the liner pipe 2 to form a stepped notch 3 with the height a of 3.75 mm and the depth b of 10 mm, where the wall thickness L₂ (2 mm) of the liner pipe 2<the height a (3.75 mm) of the notch<the wall thickness (17 mm) of 25% bimetal composite pipe;

### (2) Preparation of Cladding Powder

weighing out 0.23 g of carbon powder, 164.11 g of chromium powder, 25.6 g of niobium powder, 0.75 g of silicon powder, 65.5 g of molybdenum powder, 2.26 g of manganese powder, 30.11 g of iron powder, and 299.06 g of nickel powder, and mixing evenly to obtain surfacing layer powder and isolation layer powder respectively, with the particle size of 20 μm, and the sphericity of 0.8;

### (3) Cleaning and Preheating of the Composite Pipe

performing cleaning and 110° C. preheating treatment on the bimetal composite pipe with the stepped notch 3 machined in step (1);

### (4) Laser Cladding Surfacing

loading the surfacing layer powder in step (2) into the powder feeder of the laser cladding equipment, keeping the composite pipe rotating, cladding the surfacing layer powder in the stepped notch 3 in step (1) by using the synchronous laser cladding process in the cladding direction from the inside to the outside, pausing the laser cladding equipment after the surfacing layer 4 was formed, where the roundness deviation range of the inner wall surface of the surfacing layer 4 was 0.7%; and polishing the end face of the surfacing layer 4 so that the end face of the surfacing layer 4 was flush with the end face of the composite pipe;
where the parameters of the synchronous laser cladding process were: laser power of 2200 W, a powder feeding speed of 10 g/min, a spot diameter of 0.2 mm, a scanning speed of 100 mm/min, and protective gas of argon;

### (5) Groove Designing and Machining

machining a V-shaped groove at the end face of the composite pipe after the surfacing in step (4), where the blunt edge length c was 5.5 mm, the blunt edge thickness d was 2.2 mm, and the single-sided groove angle β was 30°;

### (6) Groove Cleaning and Preheating

performing cleaning and 110° C. preheating treatment on the V-shaped groove of the end face of the composite pipe in step (5);

### (7) Adding of an Isolation Layer to the Groove

loading the isolation layer powder in step (2) into the powder feeder of the laser cladding equipment, keeping the composite pipe rotating, cladding the isolation layer powder on the inclined surface 5 of the V-shaped groove in step (5) by using the synchronous laser cladding process in the cladding direction from the inside to the outside, and stopping the laser cladding equipment after the isolation layer 6 was formed, where the height of the isolation layer was uniform and consistent, the single-sided groove angle β was maintained at 30°, and the thickness e was 4 mm,
where the parameters of the synchronous laser cladding process were: laser power of 2200 W, a powder feeding speed of 10 g/min, a spot diameter of 0.2 mm, a scanning speed of 100 mm/min, and protective gas of argon;

### (8) Groove Cleaning and Fit-Up

performing quality inspecting and cleaning on the grooves of the two processed to-be-welded composite pipes to ensure that the grooves and the surrounding areas thereof were intact, bright and clean, and then performing groove fit-up, where the gap was 3 mm;

### (9) Welding and Filing of a Base Layer

performing base layer welding on the bottom of the groove by using tungsten inert gas welding under inert gas protection to form a base weld layer 7, and then performing fill welding on the base weld layer 7 by using the tungsten inert gas welding to form a first fill layer 8, a second fill layer 9 and a third fill layer 10,
where the welding material for the base layer welding was a welding wire with a composition similar to that of the liner pipe 2, where the mass ratio of Cr to Ni was 1:3, the welding current was 100 A, and the welding speed was 4 cm/min, and
the welding material for the fill welding was a welding wire with a composition similar to that of the liner pipe 2, where the mass ratio of Cr to Ni was 1:3, the welding current was 100 A, and the welding speed was 5.5 cm/min;

### (10) Welding of a Base Layer Cover

performing cover welding on the base layer by using shielded metal arc welding to form a cover layer 11,
where the welding material for the cover welding was a welding wire with a composition similar to that of the liner pipe, where the mass ratio of Cr to Ni was 1:3, the welding current was 60 A, and the welding speed was 7.5 cm/min.

### Performance Testing

### 1. Element Detection

The root weld area of the base layer welding of the composite pipe in Example 1 was sampled and subjected to elemental detection, where the mass percentage of Cr element was 21.8%, the mass percentage of Ni element was 60%, and the mass percentage of C element was 0.01%.

The root weld area of the base layer welding of the composite pipe in Example 2 was sampled and subjected to elemental detection, where the mass percentage of Cr element was 22.3%, the mass percentage of Ni element was 62%, and the mass percentage of C element was 0.02%.

The above experiments demonstrate that the composite pipe formed by the welding method of the present disclosure has relatively high tensile strength, which was not much different from that of the end surfacing technique, and has high generalization value.

### 2. Corrosion Resistance Test

Corrosion resistance verification tests were conducted on the composite pipes of Example 1 and Example 2 under acidic gas fields, respectively. The specific steps were as follows:
(1) sampling the root of the weld seam of the composite pipe by using wire electrical discharge machining technique, where the sample was an arc-shaped sample (height of 30 mm, thickness of 2 mm, arc central angle of) 22.5°, and simultaneously the weld seam was ensured to be located at the symmetrical center;
(2) performing step-by-step polishing on the surface of the sample by using 400 #, 800 #, 1000 #, 1500 # and 2000 # silicon carbide sandpaper, then cleaning the sample with acetone and ethanol in sequence, drying with cold air after cleaning, and then weighing for later use;
(3) placing the prepared samples (3 samples) into a high-temperature and high-pressure reactor, adding the prepared acidic 3% wt NaCl solution (pH=3, fully deoxygenated), then sealing the high-temperature and high-pressure reactor, introducing nitrogen gas for deoxygenization, and introducing 3 MPa CO₂/2 MPa H₂S after heating to 50° C., where the test time was 168 h; and
(4) after the test, taking out the samples, then cleaning by using film removal solution, deionized water and ethanol in sequence; drying with cold air, then weighing and calculating the corrosion rate; and then observing whether there were holes and cracks on the sample surface by using a stereomicroscope.

The results were as shown in Table 1 and Table 2.

TABLE 1
Corrosion Rate, Surface Condition, and Hole and Crack
Condition of Composite Pipe Sample in Example 1

| Sample | Corrosion Rate | Surface | Whether Holes and Cracks |
|---|---|---|---|
| Number | (mm/y) | Condition | are present |
| 1# | 0.0004 | Test piece | no |
| | | being bright | |
| 2# | 0.0005 | Test piece | no |
| | | being bright | |
| 3# | 0.0005 | Test piece | no |
| | | being bright | |

TABLE 2
Corrosion Rate, Surface Condition, and Hole and Crack
Condition of Composite Pipe Sample in Example 2

| Sample | Corrosion Rate | Surface | Whether Holes and Cracks |
|---|---|---|---|
| Number | (mm/y) | Condition | are present |
| 1# | 0.0003 | Test piece | no |
| | | being bright | |
| 2# | 0.0005 | Test piece | no |
| | | being bright | |
| 3# | 0.0006 | Test piece | no |
| | | being bright | |

As shown in Table 1 and Table 2, the average corrosion rate of the composite pipe samples in Example 1 and Example 2 is much lower than the mild corrosion standard (0.005 mm/y), and no holes or cracks are observed on the sample surfaces.

The above experiments demonstrate that the composite pipe formed by the welding method of the present disclosure has excellent corrosion resistance in acidic gas fields and can meet the application conditions.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A welding method for bimetal composite pipes for an acidic environment, comprising the following steps:
(1) machining of a stepped notch
first, preparing a finished bimetal composite pipe formed by hydroforming and cleaning a surface and an end face, and then cutting off a certain range of one side of a pipe end near a liner pipe to form the stepped notch,
wherein the stepped notch has a height a of 2.5~4 mm and a depth b of 8~12 mm, and a wall thickness L₂ of the liner pipe<the height a of the notch<a wall thickness (L₁+L₂) of 25% bimetal composite pipe;
(2) preparation of cladding powder
mixing carbon powder, chromium powder, niobium powder, silicon powder, molybdenum powder, manganese powder, iron powder and nickel powder evenly to obtain surfacing layer powder and isolation layer powder respectively,
wherein the surfacing layer powder and the isolation layer powder, by mass percentage, each comprise 0.01%~0.03% of carbon powder, 21%~22% of chromium powder, 3%~3.5% of niobium powder, 0.01%~0.1% of silicon powder, 8%~10% of molybdenum powder, 0.1%~0.3% of manganese powder, and 1%~5% of iron powder, with a balance being nickel powder; and
the surfacing layer powder and the isolation layer powder have a particle size of 5~50 μm and a sphericity of 0.7~0.9;
(3) cleaning and preheating of the composite pipe
performing cleaning and preheating treatment on the bimetal composite pipe with the stepped notch machined in step (1);
(4) laser cladding surfacing
loading the surfacing layer powder in step (2) into a powder feeder of laser cladding equipment, keeping the composite pipe rotating, cladding the surfacing layer powder in the stepped notch in step (1) by using a synchronous laser cladding process in a cladding direction from an inside to an outside, pausing the laser cladding equipment after a surfacing layer is formed, wherein a roundness deviation range of an inner wall surface of the surfacing layer is 0.5%~1%; and polishing an end face of the surfacing layer so that the end face of the surfacing layer is flush with the end face of the composite pipe;
(5) groove designing and machining
machining a V-shaped groove on the end face of the composite pipe after the surfacing in step (4),
wherein for the V-shaped groove, a blunt edge length c is 3~6 mm, a blunt edge thickness d is 2~2.5 mm, and a single-sided groove angle β is 30°±3°;
(6) groove cleaning and preheating
performing cleaning and preheating treatment on the V-shaped groove of the end face of the composite pipe in step (5);
(7) adding of an isolation layer to the groove
loading the isolation layer powder in step (2) into the powder feeder of the laser cladding equipment, keeping the composite pipe rotating, cladding the isolation layer powder on an inclined surface of the V-shaped groove in step (5) by using the synchronous laser cladding process in the cladding direction from the inside to the outside, and stopping the laser cladding equipment after the isolation layer is formed,
wherein a height of the isolation layer is uniform and consistent, the single-sided groove angle β is maintained at 30°±3°, and a thickness e is 2~5 mm;
(8) groove cleaning and fit-up
performing quality inspecting and a cleaning on grooves of two processed to-be-welded composite pipes to ensure that the grooves and surrounding areas thereof are intact, bright and clean, and then performing groove fit-up;
(9) welding and filing of a base layer
performing base layer welding on a bottom of the groove by using tungsten inert gas welding under inert gas protection to form a base weld layer, then performing fill welding on the base weld layer by using the tungsten inert gas welding to form a first fill layer, a second fill layer and a third fill layer; and
(10) welding of a base layer cover
performing cover welding on the base layer by using shielded metal arc welding to form a cover layer.

2. The welding method for bimetal composite pipes for an acidic environment according to claim 1, wherein in step (3) and step (6), a temperature for the preheating treatment is 80~250° C.

3. The welding method for bimetal composite pipes for an acidic environment according to claim 1, wherein in step (4) and step (7), parameters of the synchronous laser cladding process are: laser power of 2000~4500 W, a powder feeding speed of 5~15 g/min, a spot diameter of 0.1~0.5 mm, a scanning speed of 90~450 mm/min, and protective gas of argon.

4. The welding method for bimetal composite pipes for an acidic environment according to claim 1, wherein in step (8), a gap between groove assemblies is 2~3 mm.

5. The welding method for bimetal composite pipes for an acidic environment according to claim 1, wherein in step (9), for the base layer welding, a welding current is 90~110 A, and a welding speed is 3~4 cm/min; and
for the fill welding, the welding current is 90~110 A, and the welding speed is 4~6 cm/min.

6. The welding method for bimetal composite pipes for an acidic environment according to claim 1, wherein in step (10), for the cover welding, a welding current is 50~70 A, and a welding speed is 7~9 cm/min.
